(19) United States
(12) Patent Application Publication
(10) Pub. No.: US 2008/0182039 A1
(43) Pub. Date: Jul. 31, 2008

(54) Cast Product and Method

(76) Inventor: Christopher D. Jones, Fort Wayne, IN (US)

Correspondence Address: BARNES & THORNBURG LLP, 600 ONE SUMMIT SQUARE, FORT WAYNE, IN, 46802, US

(21) Appl. No.: 12/014,994

(22) Filed: Jan. 16, 2008

Related U.S. Application Data
(60) Provisional application No. 60/886,685, filed on Jan. 26, 2007.

(51) Int. Cl. B32B 27/00; B29C 39/02; B29C 39/12

(52) U.S. Cl. 428/15; 264/299; 264/241

(57) ABSTRACT

A cast product and method for forming same. Typically, the cast product includes waste materials to form a product that resembles natural stone. In some embodiments, the casting media may include granulated fiberglass that is a waste by-product of a manufacturing process. Some embodiments are contemplated in which the casting media may also include waste resin that was purged during a production process. The use of these waste products reduces the costs for the cast product, as well as harm to the environment.

### RELATED APPLICATION

This application claims priority to U.S. Provisional Application Ser. No. 60/886,685, filed Jan. 26, 2007, the entire disclosure of which is hereby incorporated by reference.

### TECHNICAL FIELD

This invention generally relates to a cast product and method for creating a cast product. In particular, the present invention relates to a cast product that uses waste materials to resemble natural stone.

### BACKGROUND

The construction industry uses a variety of natural products, such as stone, bricks, and tile, to create an aesthetic appeal. These products may be used on a building's exterior, such as walls, or inside the building, such as in a tile backsplash. In some cases, natural stone is used in other products, such as birdbaths, water features, sculptures, and walkways. Due to the weight and cost of natural stone, however, there have been various attempts to create a manmade product that resembles natural stone.

Foam panels have been devised that look similar to stone. While foam panels are light, which eases installation, durability is problematic. For example, the panels tend to dent and break easily. While the exterior surface is colored, cuts to the surface reveal the white interior, which reduces the realism of the panels. In addition, the panels do not feel like stone to the touch.

Plastic panels that are molded to resemble stone are also known. However, these panels are not very realistic and do not feel like natural stone.

Other panelized products are known that are built from individual cultured stone, which is laid up in masonry fashion. However, these panels are very heavy and require either several men or a lift truck for installation.

Accordingly, there is a need for a manmade product that realistically resembles natural stone, but is relatively lightweight.

### SUMMARY

According to one aspect, the invention provides a method for creating a cast product that resembles natural stone. The method may include the step of providing a casting media into a mixer. The casting media may be mixed and then dispensed into at least one mold cavity. The casting media is then cured to form a cast product. In some cases, the casting media comprises a waste filler, a waste resin and a virgin resin. In some embodiments, the waste filler includes granulated fiberglass that is a by-product of a manufacturing process. Embodiments are contemplated in which the waste resin includes a waste resin that was purged during a manufacturing process.

According to another aspect, the invention provides a construction panel formed by a process in which a casting media is provided to a mixer and mixed. The casting media is then dispensed into at least one mold cavity. An insulation panel is placed into the mold cavity, such that the panel is suspended in the casting media. Typically, the casting media includes waste filler, waste resin and virgin resin. In some embodiments, the waste filler is approximately 25-35% of the casting media by weight. Embodiments are contemplated in which the waste resin is approximately 25-35% of the casting media by weight. In some embodiments, the internal temperature of the casting media is approximately 130-135° F., prior to dispensing the casting media into the mold cavity.

### BRIEF DESCRIPTION OF THE DRAWINGS

The present disclosure will be described hereafter with reference to the attached drawings which are given as non-limiting examples only, in which:

FIG. 1 is a diagrammatical view of an example system for creating a stone-like product according to an embodiment of the present invention;

FIG. 2 is a flow chart of a method for forming a stone-like product according to an embodiment of the present invention;

FIG. 3 is a cross-sectional view of an example wall section constructed according to an embodiment of the present invention; and

FIG. 4 is a front view of an example wall section constructed according to an embodiment of the present invention.

Corresponding reference characters indicate corresponding parts throughout the several views. The components in the figures are not necessarily to scale, emphasis instead being placed upon illustrating the principals of the invention. The exemplification set out herein illustrates embodiments of the invention, and such exemplification is not to be construed as limiting the scope of the invention in any manner.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

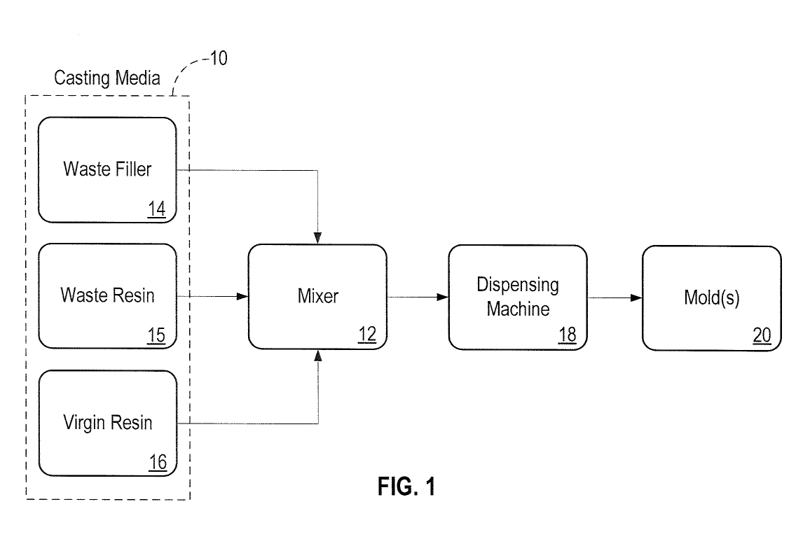

FIG. 1 shows a diagrammatical view of an example system for making a cast product. In the example shown, a casting media 10 is put into a mixer 12. Preferably, the casting media 10 comprises a waste filler 14, a waste resin 15, and a virgin resin 16. In some cases, other fillers, pigments, UV stabilizers, fire retardants, etc., may be added to the casting media, depending on the desired end product. By way of example only, the casting media 10 may comprise 15% pigments, UV stabilizers, fire retardants, etc., in some embodiments.

Preferably, the waste filler 14 is granulated fiberglass, which would typically be disposed of as a waste product. For example, the waste filler 14 could be cured fiberglass trimmings once ground up to be mixed and dispensed in this process. In some cases, for example, the granulated fiberglass may be a by-product of automotive or marine part manufacturing processes. For example, the waste filler 14 may be “router dust,” which is typically made from a router process, such as trimming a car body part.

The router dust is often regulated as a solid waste material, which is required to be disposed of in a landfill. This increases the manufacturing costs for the automotive industry (or other industries that create this by-product), both in terms of costs for landfill disposal and costs to transport the dust to a landfill. Due to these costs, the router dust is available at substantially no cost for use as the waste filler 14, which results in substantial savings for the end product. Moreover, the use of router dust as the waste filler 14 reduces the disposal of the router dust in a landfill, which reduces harm to the environment.

In some embodiments, the waste filler 14 may comprise about 25-35% of the casting media 10 by weight. The amount of waste filler 14 used in the casting media 10 depends, in part, on the thickness of resin and the desired consistency of the casting media. Preferably, the waste filler 14 may be used without any virgin fillers. In some embodiments, however, virgin fillers may be used with the waste filler 14.

Preferably, the waste resin 15 is waste resin that has been purged during a production process and would typically be disposed of as a waste product. The use of purged resin (which would otherwise be destined for a landfill) allows the end product to resemble stone, which may be rough and have imperfections. For example, the waste resin 15 may be saturated, polyester resin that has been purged in sheet molding compound production during a changeover to a different resin. The particular type of purged resin is not important. Since the purged resin is often required to be disposed of in a landfill, the purged resin is typically available at substantially no cost for use as the waste resin 15, which results in substantial savings for the end product. Moreover, the use of purged resin as the waste resin 15 reduces the disposal of the purged resin in a landfill, which reduces harm to the environment. In some embodiments, the waste resin 15 may comprise about 25-35% of the casting media 10 by weight. The amount of waste resin 15 used in the casting media 10 depends, in part, on the desired look of the end product.

In some embodiments, the virgin resin 16 may be saturated, polymer resins, such as those found in basic cultured marble products. Any low viscosity, low shrink resin could be used. By way of example only, the virgin resin 16 could be the product sold under the name RCI 32141-01 by Ashland Chemical Co. of Dublin, Ohio. In some cases, the virgin resin 16 may comprise about 25-35% of the casting media 10 by weight.

In some embodiments, the mixer 12 may be a standard high-shear mixer, such as with a 500 to 5,000 pound bulk container, for example. The mixer 12 preferably thoroughly mixes the waste filler 14 with the waste resin 15 and the virgin resin 16. For example, the mixer 12 may include a mixing blade that rotates at 1,000 to 2,500 RPM, depending on the viscosity of the casting media 10, for example. In some cases, the mixer 12 mixes the casting media 10 at high speeds to increase the temperature of the casting media 10. Preferably, the temperature of the casting media 10 rises approximately 10° F. above ambient temperature during the mixing process. In some cases, an inline temperature gauge may be used to determine the temperature during mixing. By way of example only, the casting media may be mixed between about 15-45 minutes in some embodiments.

Once mixed, the casting media 10 is then provided to a dispensing machine 18, which dispenses the casting media 10 into mold(s) 20. By way of example only, the dispensing machine may be a Cast Polymer System sold by GlasCraft of Indianapolis, Ind. In some embodiments, the dispensing machine 18 may include temperature controls that may be used to increase the temperature of the casting media 10. For example, the dispensing machine 18 may include a heating element. In some cases, the temperature of the casting media 10 may be adjusted by changing the flow rate through the heating element. By way of example only, the temperature of the casting media 10 could be approximately 130-135° F. prior to being dispensed into the mold 20. It should be appreciated that the casting media 10 may be recirculated through the heating element until the temperature of the casting media has been elevated to the desired temperature. Typically, the dispensing machine 18 may add a hardener to the casting media 10 when dispensing the casting media 10 into the mold.

The mold 20 may be a standard flexible mold. The mold 20 could be configured to create a wide variety of products. By way of example only, the mold 20 could be configured to make individual stacking, landscape stones, quoin sections for accents on the exterior of homes, mobile home pier blocks to take the place of cinder blocks, back splash tile sections, wall sections, fireplace surrounds (which may include a mantel and hearth), decorative pool fountains, side walk sections, traffic barriers, zoo and or theme park scenery, extruded exterior siding, wood planking substitute, spill-ways, picnic tables (e.g., typical or ornate), park benches (e.g., typical or ornate), mobile home skirting, deck skirting, 3 season room walls, spa gazebos, spa cabinets, thermal door threshold, shipping spacers, decorative mirror frames, sculpture reproductions, inner locking retaining walls, foundation cover, reproduce ornate architecture features, commercial waste can exterior (i.e., replace pebbles), bird baths, pool outcropping, and live stock feeders.

Once the casting media 10 is dispensed into the cavities of the mold 20, the media 10 is cured. The curing times are substantially lower than expected from a typical polyester resin curing process. This is believed to be due to the percentage of waste filler 14 used in the casting media and the elevated temperature of the casting media 10 prior to dispensing. For example, the curing time may be only 15 minutes in some cases.

The end product created by the system is approximately 50% lighter than natural stone and 25% lighter at the same volume than the loose cultured stone on the market. Due to the relative lightness of the end product, no concrete footing or special support is typically required. Since the end product carries its color throughout the entire casting, this increases the longevity of the product in its environment.

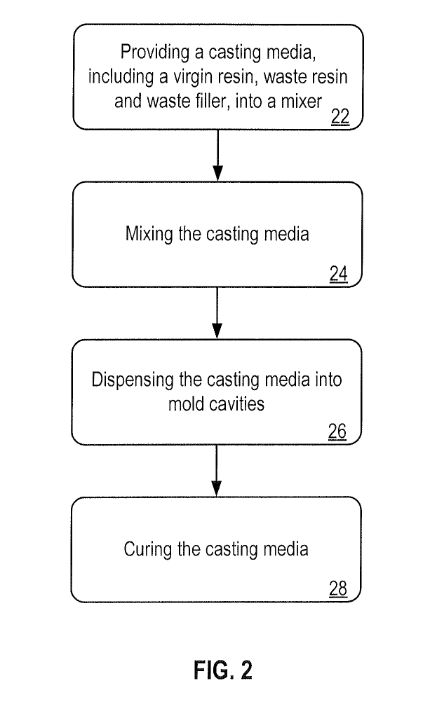

Referring to FIG. 2, the casting media 10 is put into the mixer 12, as indicated by step 22. The mixer 12 mixes the casting media 10, as indicated by step 24. Typically, the casting media 10 is mixed until its temperature is about 10° F. above ambient temperature. The casting media 10 is then put in a dispensing machine 18, as indicated by step 26, which typically increases the temperature of the casting media 10 to approximately 130-135° F. prior to dispensing the casting media 10 into mold cavities. The casting media 10 is then cured, as indicated by step 28, typically at ambient temperature.

For purposes of example only, consider a casting media 10 comprising about 1,250 pounds of waste filler 14, about 1,250 pounds of waste resin 15, about 1,250 pounds of virgin resin 16, and about 500 pounds of pigment, fire retardant, and UV stabilizer. The casting media 10 is placed into a mixer 12 and mixed at approximately 2,000 RPMs for about 35 minutes. The mixed casting media 10 is then provided to a dispensing machine 18. The dispensing machine 18 increases the temperature of the casting media 10 and dispenses the media 10 into cavities of a mold 20. In some cases, the temperature of the casting media 10 may be about 135° F. when poured into the mold. The mold is then allowed to cure. Once cured, the end product may be removed from the mold.

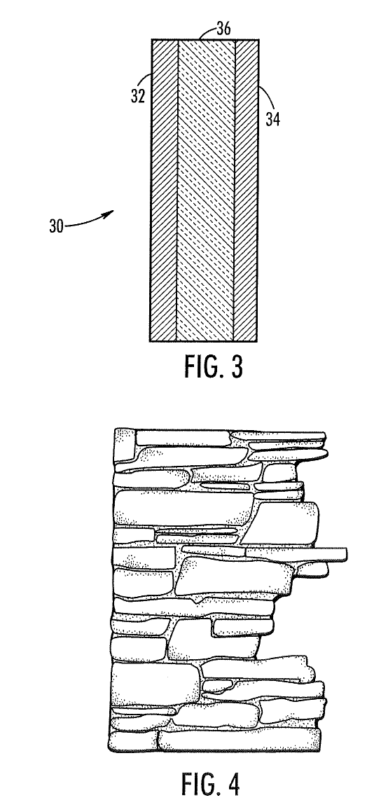

Referring to FIG. 3, the system may be used to create a construction panel 30, such as a wall section or floor section that includes an insulated core. In the example shown, the construction panel 30 includes a first cast layer 32 and a second cast layer 34 surrounding an insulation layer 36. The cast layers 32 and 34 may be formed using the system and method described herein. Typically, the insulation layer 36 may be placed in the mold shortly after pouring in the cast layers 32 and 34. A retaining structure, such as wires, may be used to maintain the desired positioning of the insulation layer 36 with respect to the cast layers 32 and 34. In some cases, the insulation layer 36 may be an insulation panel that is certified for exterior construction, such as a R-6 insulation panel. In some cases, by way of example only, the construction panel 30 may be approximately 32 inches by 48 inches in some embodiments. Depending on the particular application, one or more edges of the construction panel 30 may be jagged to interlock with other wall sections, such as the example shown in FIG. 4, thereby creating a continuous wall without a visible seam. The construction panel 30 may be customized at installation, such as to accommodate electrical outlets, etc. For example, the construction panel 30 may be field cut using standard woodworking tools and fashioned into custom sizes and shapes by drilling, cutting, or grinding. To install, the construction panel 30 may be screwed onto a wall, for example. Other fasteners and/or adhesives could be used to mount the construction panel 30 to an existing wall or floor. Typically, the construction panel 30 does not require any substrate for reinforcement.

Although the present disclosure has been described with reference to particular means, materials and embodiments, from the foregoing description, one skilled in the art can easily ascertain the essential characteristics of the invention and various changes and modifications may be made to adapt the various uses and characteristics without departing from the spirit and scope of the invention.

What is claimed is:

1. A method for creating a product resembling natural stone, the method comprising the steps of:
providing a casting media to a mixer;
mixing the casting media;
dispensing the casting media into at least one mold cavity;
curing the casting media to yield a product resembling natural stone; and
wherein the casting media comprises waste filler, waste resin and virgin resin.

2. The method of claim 1, wherein the waste filler comprises router dust.

3. The method of claim 1, wherein the waste filler comprises granulated fiberglass that is a by-product of a manufacturing process.

4. The method of claim 3, wherein the waste filler is formed by trimming at least one of a fiberglass automotive part and a fiberglass marine part.

5. The method of claim 1, wherein the waste resin comprises purged resin.

6. The method of claim 5, wherein the waste resin comprises a waste resin that was purged during a manufacturing process.

7. The method of claim 1, wherein the waste filler comprises approximately 25-35% of the casting media by weight.

8. The method of claim 7, wherein the waste resin comprises approximately 25-35% of the casting media by weight.

9. The method of claim 1, wherein the casting media is mixed until reaching an internal temperature of about 10° F. above ambient temperature.

10. The method of claim 1, further comprising the step of increasing an internal temperature of the casting media to approximately 130-135° F. prior to dispensing the casting media into the mold cavity.

11. A construction panel formed by a process comprising the steps of:
providing a casting media to a mixer;
mixing the casting media;
dispensing the casting media into at least one mold cavity;
placing an insulation panel into the mold cavity such that the insulation panel is suspended in the casting media;
curing the casting media to yield a construction panel resembling natural stone; and
wherein the casting media comprises waste filler, waste resin and virgin resin.

12. The method of claim 11, wherein the waste filler comprises approximately 25-35% of the casting media by weight.

13. The method of claim 12, wherein the waste resin comprises approximately 25-35% of the casting media by weight.

14. The method of claim 11, wherein the casting media is mixed until reaching an internal temperature of about 10° F. above ambient temperature.

15. The method of claim 11, wherein an internal temperature of the casting media is approximately 130-135° F. prior to dispensing the casting media into the mold cavity.

16. The method of claim 11, further comprising forming a jagged edge on an edge of the construction panel.

17. A method for creating a product resembling natural stone, the method comprising the steps of:
providing a waste filler comprising granulated fiberglass that is a by-product of a manufacturing process;
providing a waste resin that was purged during a manufacturing process;
providing a virgin resin;
mixing the waste filler, the waste resin and the virgin resin together to form a mixed casting media;
dispensing the mixed casting media into at least one mold cavity; and
curing the casting media to yield a product resembling natural stone.

18. The method of claim 17, further comprising the step of suspending an insulation panel in the mold cavity prior to the completion of the curing step.

19. The method of claim 17, wherein an internal temperature of the mixed casting media is elevated to approximated 130-135° F. prior to the dispensing step.

20. The method of claim 17, wherein the mold is configured to form at least one of a landscape stone, a quoin section, a pier block, a tile section, a wall section, a fireplace surround, a decorative pool fountain, a sidewalk section, a traffic barrier, exterior siding, a picnic table, a park bench, a skirting, a gazebo, a cabinet, a door threshold, a shipping spacer, a picture frame, a sculpture, a retainer wall, waste container, a birdbath, a pool outcropping, and a livestock feeder.

21. A construction panel comprising:
a first layer comprising a cast product resembling natural stone;
a second layer comprising a cast product resembling natural stone; and
an insulation layer disposed between the first layer and the second layer.

22. The construction panel of claim 21, further comprising a plurality of interlocking construction members that each includes the first layer, the second layer and the insulation layer.

23. The construction panel of claim 21, wherein the first layer comprises:
a waste filler including granulated fiberglass that is a by-product of a manufacturing process;
a waste resin that was purged during a manufacturing process; and
a virgin resin.

24. The construction panel of claim 23, wherein the insulation layer is a pre-formed insulation panel for use in exterior construction.

25. The construction panel of claim 24, wherein the insulation panel has an insulation value of approximately R-6.

26. The construction panel of claim 23, wherein the construction panel has a substantially planar shape.
